(19) United States
(12) Patent Application Publication
(10) Pub. No.: US 2019/0180169 A1
(43) Pub. Date: Jun. 13, 2019

(54) OPTIMIZATION COMPUTATION WITH SPIKING NEURONS

(71) Applicant: National Technology & Engineering Solutions of Sandia, LLC, Albuquerque, NM (US)

(72) Inventors: Stephen Joseph Verzi, Albuquerque, NM (US); Craig Michael Vineyard, Cedar Crest, NM (US); Nadine E. Miner, Albuquerque, NM (US); James Bradley Aimone, Albuquerque, NM (US)

(21) Appl. No.: 15/837,326

(22) Filed: Dec. 11, 2017

(51) Int. Cl. G06N 3/04

(52) U.S. Cl. CPC G06N 3/049

(57) ABSTRACT

A neuromorphic machine and method of determining an optimum value. The neuromorphic machine comprises a plurality of spiking neurons and a plurality of blocking neurons. The plurality of spiking neurons are configured to receive a plurality of input signals representing a plurality of input values and to implement objective functions on the plurality of input values. The plurality of blocking neurons are configured to receive the plurality of input values and output from the plurality of spiking neurons as input and to provide an output signal representing an optimum value corresponding to at least one of the plurality of input values.

### GOVERNMENT LICENSE RIGHTS

This invention was made with United States Government support under Contract No. DE-NA0003525 between National Technology and Engineering Solutions of Sandia, LLC and the United States Department of Energy. The United States Government has certain rights in this invention.

### BACKGROUND INFORMATION

### 1. Field

The present disclosure relates generally to neuromorphic computing and more specifically to using neuromorphic computing to solve optimization problems.

### 2. Background

In neuromorphic computing, also known as neuromorphic engineering, very-large-scale integration (VLSI) systems containing electronic analog circuits are used to mimic neuro-biological architectures present in the nervous system. Neuromorphic systems may include analog, digital, mixed-mode analog and digital VLSI, and software systems that implement models of neural systems. Neuromorphic computing may be implemented on the hardware level using oxide-based memristors, threshold switches, and transistors.

Considerable effort has been spent designing neuromorphic systems for addressing challenging problems in a variety of pattern-matching applications. These neuromorphic systems offer low-power architectures with intrinsically parallel and simple spiking neuron processing elements. Spiking neural networks combine multiple spiking neurons together into a platform to facilitate computation across the entire network or population of neurons.

Spiking neurons incorporate the concept of time into their operating model. Spiking neurons do not fire at a regular propagation cycle. Spiking neurons rather fire only when an intrinsic quality of the neuron reaches a specific value. When a neuron fires, it generates a signal which travels to other neurons which, in turn, increase or decrease their potentials in accordance with this signal. The current activation level may be considered to be the state of a neuron, with incoming spikes pushing this value higher, and then either firing or decaying over time.

Neuromorphic architectures have been developed to implement spiking neural networks in hardware. However, development and analysis of spiking algorithms that make efficient and effective use of spiking neural network architectures may lag behind the advances in neuromorphic machine hardware.

Numerical optimization is an important field of study in computer science, operations research, and applied mathematics. A simple form of optimization involves searching through allowed input values while tracking and recording either maximum or minimum objective function values achieved by the inputs.

Therefore, it may be desirable to provide algorithms that take advantage of spiking neural network architectures to meet application-specific needs. In particular it may be desirable to provide an algorithm for a spiking neural network to solve optimization problems.

### SUMMARY

The illustrative embodiments provide a neuromorphic machine comprising a plurality of spiking neurons and a plurality of blocking neurons. The plurality of spiking neurons are configured to receive a plurality of input signals representing a plurality of input values and to implement objective functions on the plurality of input values. The blocking neuron is a particular type of inhibitory pathway. The plurality of blocking neurons are configured to receive the plurality of input values and output from the plurality of spiking neurons as input and to provide an output signal representing an optimum value corresponding to at least one of the plurality of input values.

In another illustrative embodiment, a neuromorphic machine comprises a plurality of neuron lanes. The neuron lane is a particular type of excitatory neural pathway. Each neuron lane in the plurality of neuron lanes comprises a spiking neuron and a blocking neuron. The plurality of neuron lanes are configured to receive a plurality of input signals representing a plurality of input values and to provide an output signal representing a median value of the plurality of input values.

The illustrative embodiments also provide a method of determining an optimum value. A plurality of input signals are provided to a plurality of spiking neurons and a plurality of blocking neurons. The plurality of input signals represent a plurality of input values. The plurality of spiking neurons implement objective functions on the plurality of input values. Output from the plurality of spiking neurons is provided as input to the plurality of blocking neurons. An output signal is provided from the plurality of blocking neurons representing an optimum value corresponding to at least one of the plurality of input values.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a neuromorphic machine for optimization, in accordance with an illustrative embodiment;

FIG. 2 is a schematic illustration of a spiking neural architecture, in accordance with an illustrative embodiment;

FIG. 3 is an illustration of run-times for simulations of optimization algorithms for determining a median, in accordance with an illustrative embodiment; and

FIG. 4 is an illustration of median-filtering using an optimization algorithm for determining a median, in accordance with an illustrative embodiment.

### DETAILED DESCRIPTION

Illustrative embodiments recognize and take into account that the computational capabilities of biological systems have garnered interest within the research community seeking to develop new methods of high-speed, low-power computing. Numerous novel hardware systems have been built to instantiate neuromorphic computing principles and to solve challenging problems such as pattern recognition. In most proposed neural architectures, spiking typically may be accompanied by several other key attributes, each of which may have been used individually, previously in other artificial neural networks. Such other attributes may include, for example, without limitation, parallel processing, temporal coding, numerical precision, sparse activation and analog computation.

Illustrative embodiments also recognize and take into account that optimization is an important area of research in data processing and analysis, including machine learning and search algorithms, as well as in resilience and control in systems of systems and complex systems. Optimization techniques may be used in applied mathematics, operations research, and statistical analysis. Various statistical quantities, such as the mean, median, and mode, may be defined using an optimization-based formula.

Illustrative embodiments further recognize and take into account that, for a set of numbers, the median is an important statistic. The median is robust to outliers, requiring at least fifty percent corruption of the input set to affect its estimated value. In other words, the breakdown point for the median is fifty percent. Although the median may not be as optimal of a statistical estimator as the mean in some cases, there are situations where the median can be determined when there is no defined mean value. The median may also be useful in data processing applications, such median-value filtering of images.

Illustrative embodiments provide optimization computation with spiking neurons in a neural network architecture. Illustrative embodiments utilize the intrinsic parallel computation capabilities of spiking neural network architectures to solve optimization problems. As a specific example of an illustrative embodiment, a spiking neural architecture may be configured and used to solve the optimization problem of finding a median from a set of integers. Neural-inspired spiking algorithms in accordance with the illustrative embodiments demonstrate the benefits of combining various attributes neural architectures.

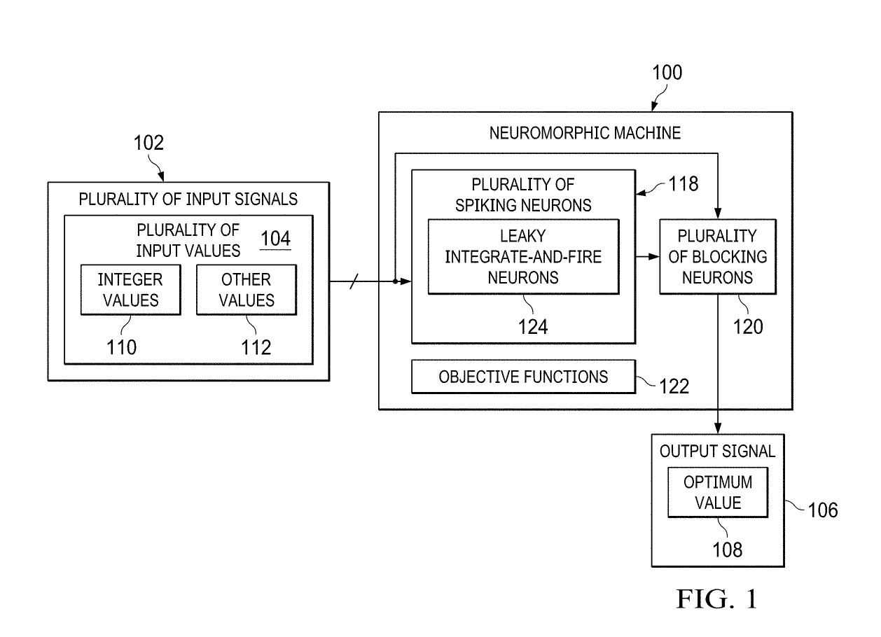

Turning to FIG. 1, an illustration of a block diagram of a neuromorphic machine for optimization is depicted in accordance with an illustrative embodiment. In accordance with an illustrative embodiment, neuromorphic machine 100 may comprise a spiking neural network architecture. For example, without limitation, neuromorphic machine 100 may be a portion or module of a larger neural network architecture.

Neuromorphic machine 100 is configured to receive plurality of input signals 102 representing plurality of input values 104. Each one of plurality of input signals 102 may indicate one of plurality of input values 104. For example, without limitation, plurality of input values 104 may comprise integer values 110, other values 112, or various combinations of integer values 110 and other values 112.

Neuromorphic machine 100 is configured to provide output signal 106 representing optimum value 108. For example, without limitation, optimum value 108 may be the one of plurality of input values 104 that is determined to be optimum for a given application. For example, without limitation, in one application in accordance with an illustrative embodiment, optimum value 108 may be the median value of plurality of input values 104.

Neuromorphic machine 100 may comprise plurality of spiking neurons 118 and plurality of blocking neurons 120. Plurality of input values 104 may be provided as inputs to plurality of spiking neurons 118 and to plurality of blocking neurons 120.

Plurality of spiking neurons 118 are configured to implement objective functions 122. Plurality of spiking neurons 118 may comprise any appropriate sub-network of spiking neurons or hierarchy of sub-networks of spiking neurons for a given application.

The output of plurality of spiking neurons 118 is provided as input to plurality of blocking neurons 120. A blocking neuron is a particular type of inhibitory pathway. Plurality of blocking neurons 120 may comprise any appropriate sub-network of blocking neurons or hierarchy of sub-networks of blocking neurons for a given application. Plurality of blocking neurons 120 are configured to block the plurality of input values 104 provided thereto from the output of neuromorphic machine 100 unless triggered by the output of one or more of plurality of spiking neurons 118 to provide one more of the plurality of input values 104 at the output of neuromorphic machine 100.

Objective functions 122 along with the arrangement of plurality of spiking neurons 118 and the arrangement of plurality of blocking neurons 120 may be implemented in neuromorphic machine 100 for a particular application such that the output of neuromorphic machine 100 is optimum value 108 for that particular application.

Illustrative embodiments are not limited to any particular implementation of plurality of spiking neurons 118, plurality of blocking neurons 120, or any other components of neuromorphic machine 100. For example, without limitation, plurality of spiking neurons 118 may be implemented as leaky integrate-and-fire neurons 124.

The illustration of neuromorphic machine 100 in FIG. 1 is not meant to imply physical or architectural limitations to the manner in which illustrative embodiments may be implemented. Other components, in addition to or in place of the ones illustrated, may be used. Some components may be optional. Also, the blocks are presented to illustrate some functional components. One or more of these blocks may be combined, divided, or combined and divided into different blocks when implemented in an illustrative embodiment.

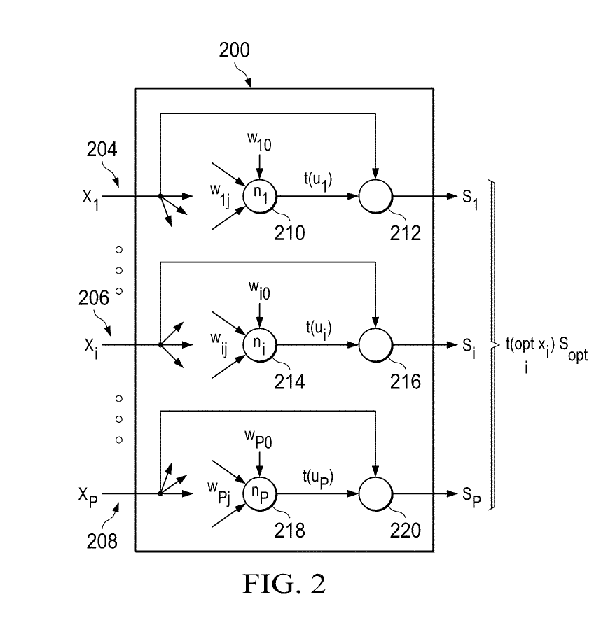

Turning to FIG. 2, a schematic illustration of a spiking neural architecture is depicted in accordance with an illustrative embodiment. Spiking neural architecture 200 may be an example of one implementation of an architecture for neuromorphic machine 100 in FIG. 1.

Spiking neural architecture 200 may comprise a plurality of neuron lanes. A neuron lane is a particular type of excitatory neural pathway. For example, without limitation, the number of neuron lanes may be the number of a plurality of input values from which an optimum value will be determined. In accordance with an illustrative embodiment, all of plurality of input values may be provided as inputs to each neuron lane in spiking neural architecture 200. In this example, input values X₁−Xₚ are provided to spiking neural architecture 200 comprises p neuron lanes.

Each neuron lane comprises a spiking neuron implementing an objective function and a blocking neuron. For example, neuron lane 204 comprises spiking neuron 210 and blocking neuron 212. Neuron lane 206 comprises spiking neuron 214 and blocking neuron 216. Neuron lane 208 comprises spiking neuron 218 and blocking neuron 220. Spiking neurons 210, 214, and 218 may be leaky integrate-and-fire neurons. Inputs to each spiking neuron may consist of any one or all of the external inputs xᵢ modified by internal weights wᵢⱼ and additional bias signal with weight wᵢ₀.

As an example, only to illustrate operation of spiking neural architecture 200 to perform an optimization function, a particular implementation of spiking neural architecture 200 to determine a median value from a plurality of input values will be described.

In this particular application, spiking neurons 210, 214, and 218 in spiking neural architecture 200 may be initialized using the value of the un-normalized univariate signed rank function for each input value in relation to all other possible input values {x₁, x₂, . . . , xₚ}. The spiking neurons receive no further input. The first one of the spiking neurons to decay to zero defines the computed median value. In this way the initial neuron values can be either positive or negative according to un-normalized univariate signed rank function, and they will each decay toward zero as needed to compute the median. The spiking neurons thus provide inhibitory signals such that the first one to decay completely will be the first to no longer inhibit the output by its corresponding blocking neuron of its originally associated input signal xᵢ, corresponding to the sample median of the original array of input values.

In spiking neural architecture 200, each input xᵢ is connected to each spiking neuron nᵢ, where the weights are set to wᵢⱼ=sign (xᵢ−xⱼ)/xⱼ. The bias weights wᵢ₀ are set to 0 in this particular application. This architecture allows computation of the signed rank utility as uᵢ=wᵢx^{T}=Σⱼ₌₁^{N}sign(xi−xj). Note that if multiple input values correspond to the same value as the sample median, then all of their associated spiking neurons will spike simultaneously. If a single spike is necessary downstream, other appropriate methods may be used to ensure that only a single spiking neuron is allowed to spike.

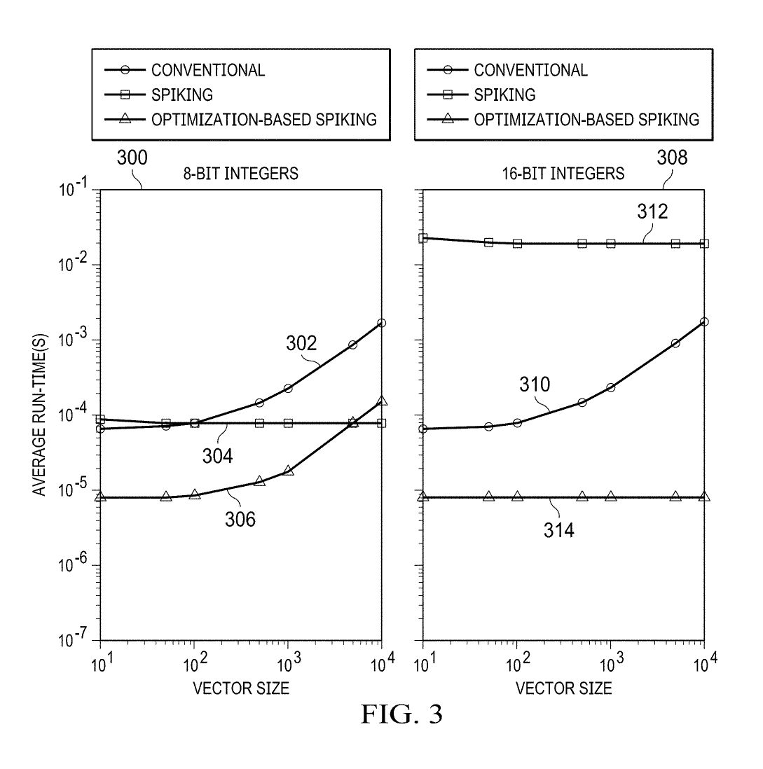

Turning to FIG. 3, an illustration of run-times for simulation of optimization algorithms for determining a median is depicted in accordance with an illustrative embodiment. Simulation results for the algorithm for determining a median using spiking neural architecture 200 in FIG. 2 are shown on the left 300 where k=255 and on the right 308 where k=65536 and N∈{11, 51, 101, 501, 1001, 5001, 10001}. Lower values are better.

The results show that as N surpasses 100, the average run-time 304 and 312 are approaching their optimal constant runtime value 306 and 314. These illustrated simulation results also show the results 302 and 310 for a conventional non-parallel algorithm for determining a median for comparison.

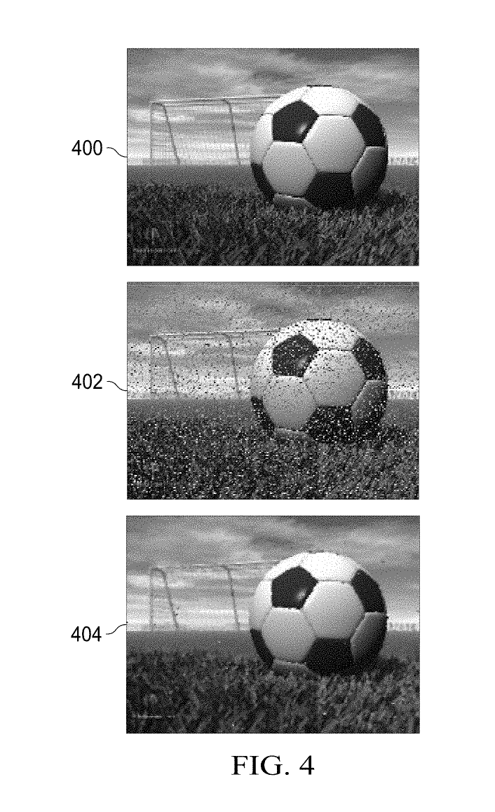

Turning to FIG. 4, an illustration of median-filtering using an optimization algorithm for determining a median is depicted in accordance with an illustrative embodiment. The images presented in FIG. 4 are an example of an image processing result for median-filtering using the algorithm for determining a median using spiking neural architecture 200 in FIG. 2.

In this example, image 400 on the top shows a 225×300 (pixel) gray-scale soccer ball image. Second image 402 in the middle is the result of adding 10% uniformly random noise to first image 400 on a pixel by pixel basis where the noisy pixel value is set at 256 minus the original grayscale pixel value. Third image 404 on the bottom shows the results of using an optimization-based spiking algorithm in accordance with an illustrative embodiment for computing the median applied upon each pixel in the noisy image. As shown, optimization-based median filtering in accordance with an illustrative embodiment may be used to clean out noise from a noisy image.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A neuromorphic machine, comprising:
a plurality of spiking neurons configured to receive a plurality of input signals representing a plurality of input values and to implement objective functions on the plurality of input values; and
a plurality of blocking neurons configured to receive the plurality of input values and output from the plurality of spiking neurons as input and to provide an output signal representing an optimum value corresponding to at least one of the plurality of input values.

2. The neuromorphic machine of claim 1, wherein the plurality of spiking neurons and the plurality of blocking neurons are arranged in a plurality of neuron lanes, wherein each neuron lane in the plurality of neuron lanes comprises a spiking neuron and a blocking neuron.

3. The neuromorphic machine of claim 2, wherein a number of the plurality of neuron lanes corresponds to a number of the plurality of input signals.

4. The neuromorphic machine of claim 2, wherein an objective function for the spiking neuron in the one of the plurality of lanes considers one of the plurality of input values in relation to all of the other plurality of input values.

5. The neuromorphic machine of claim 4, wherein the blocking neuron in the one of the plurality of lanes is configured to provide the one of the plurality of input values as the optimum value in response to an output of the objective function of the spiking neuron.

6. The neuromorphic machine of claim 1, wherein the plurality of spiking neurons comprise leaky integrate-and-fire neurons.

7. The neuromorphic machine of claim 1, wherein the plurality of input values are integer values.

8. The neuromorphic machine of claim 1, wherein the output signal represents a median value of the plurality of input values.

9. A neuromorphic machine, comprising:
a plurality of neuron lanes, wherein each neuron lane in the plurality of neuron lanes comprises a spiking neuron and a blocking neuron; and
wherein the plurality of neuron lanes are configured to receive a plurality of input signals representing a plurality of input values and to provide an output signal representing a median value of the plurality of input values.

10. The neuromorphic machine of claim 9, wherein a number of the plurality of neuron lanes corresponds to a number of the plurality of input signals.

11. The neuromorphic machine of claim 9, wherein the spiking neuron implements an objective function.

12. The neuromorphic machine of claim 11, wherein the objective function considers one of the plurality of input values in relation to all of the other plurality of input values.

13. The neuromorphic machine of claim 12, wherein the blocking neuron is configured to provide the one of the plurality of input values as the median value in response to an output of the objective function of the spiking neuron.

14. The neuromorphic machine of claim 9, wherein the spiking neuron is a leaky integrate-and-fire neuron.

15. The neuromorphic machine of claim 9, wherein the plurality of input values are integer values.

16. A method of determining an optimum value, comprising:
providing a plurality of input signals to a plurality of spiking neurons and a plurality of blocking neurons, wherein the plurality of input signals represent a plurality of input values, and wherein the plurality of spiking neurons implement objective functions on the plurality of input values;
providing output from the plurality of spiking neurons as input to the plurality of blocking neurons; and
providing an output signal from the plurality of blocking neurons representing an optimum value corresponding to at least one of the plurality of input values.

17. The method of claim 16, wherein the plurality of spiking neurons and the plurality of blocking neurons are arranged in a plurality of neuron lanes, wherein each neuron lane in the plurality of neuron lanes comprises a spiking neuron and a blocking neuron.

18. The method of claim 17, wherein a number of the plurality of neuron lanes corresponds to a number of the plurality of input signals.

19. The method of claim 17, wherein:
an objective function of the spiking neuron in a neuron lane in the plurality of neuron lanes considers one of the plurality of input values in relation to all of the other plurality of input values; and
the blocking neuron in the neuron lane is configured to provide the one of the plurality of input values as the optimum value in response to an output of the objective function of the spiking neuron.

20. The method of claim 16, wherein the output signal represents a median value of the plurality of input values.
